(19) United States
(12) Patent Application Publication
(10) Pub. No.: US 2013/0130553 A1
(43) Pub. Date: May 23, 2013

(54) ELECTRICAL CONNECTOR MOUNTING SYSTEM

(71) Applicant: Evan V. Thomas, West Chester, OH (US)

(72) Inventor: Evan V. Thomas, West Chester, OH (US)

(21) Appl. No.: 13/301,040

(22) Filed: Nov. 21, 2011

(51) Int. Cl. H01R 13/40

(52) U.S. Cl. 439/625

(57) ABSTRACT

A flexible connector system that includes a multi-terminal conductor, a housing that at least partially houses the multi-terminal conductor, a base member and complementary connection elements for connecting the housing and the base member.

### BACKGROUND OF THE INVENTION

The present invention relates to power connectors, and in particular a power connector mounting system. Currently common mounting techniques amount to no more than ad hoc techniques and include rope, zip ties, or just allowing connections to lie on the ground. These approaches subject connectors to unwanted and unnecessary environmental and physical stress. For example, rope obviously degrades over time, particularly in damp environments. In addition, simply letting connections lie on the ground potentially subjects a connection to unwanted water and may be a safety hazard. Thus, a safe and convenient electrical connector mounting system is needed to avoid the unsafe and haphazard approach commonly used in power distribution systems.

For example, FIG. 1 illustrates a known wiring installation that comprises a hodgepodge of elements. FIG. 1 shows three connectors 5, 10, and 15 connecting three sets of wire assortments. The connectors 5, 10, and 15 are held to a common hardware store type shelving track 20 by plastic tie wraps 25. Common angle brackets 30 support the weight of connectors 5 and 10. As mentioned above, in other installations, rope is used to hold the connectors up off the floor.

### SUMMARY OF THE DISCLOSURE

It is an object of the present invention to provide an electrical connector mounting system that is easy to use.

It is another object of the present invention to provide an electrical connector mounting system that does not require special tools to install or to use.

It is still another object of the present invention to provide an electrical connector mounting system that provides a safe mounting for electrical connectors.

It is a further object of the present invention to provide an electrical connector mounting system that can be used in a variety of physical environments. The above and other objects of the present invention can be achieved by a connector system comprising: a multi-terminal conductor; a housing arranged to at least partially house the multi-terminal conductor; a base member; and complementary connection elements configured to provide connection of the housing and the base member.

### BRIEF DESCRIPTION OF THE DRAWINGS

FIG. 1 is a schematic diagram of a conventional mounting system.

FIG. 2 is a schematic, perspective view of an embodiment in accordance with the present invention.

FIG. 3 is a schematic illustration of an exemplary multi-terminal conductor in accordance with an embodiment of the present invention.

FIG. 4 is a perspective, schematic view an embodiment of a connector system in accordance with the present invention.

FIG. 5 is a schematic, perspective view of a portion of the FIG. 4 embodiment.

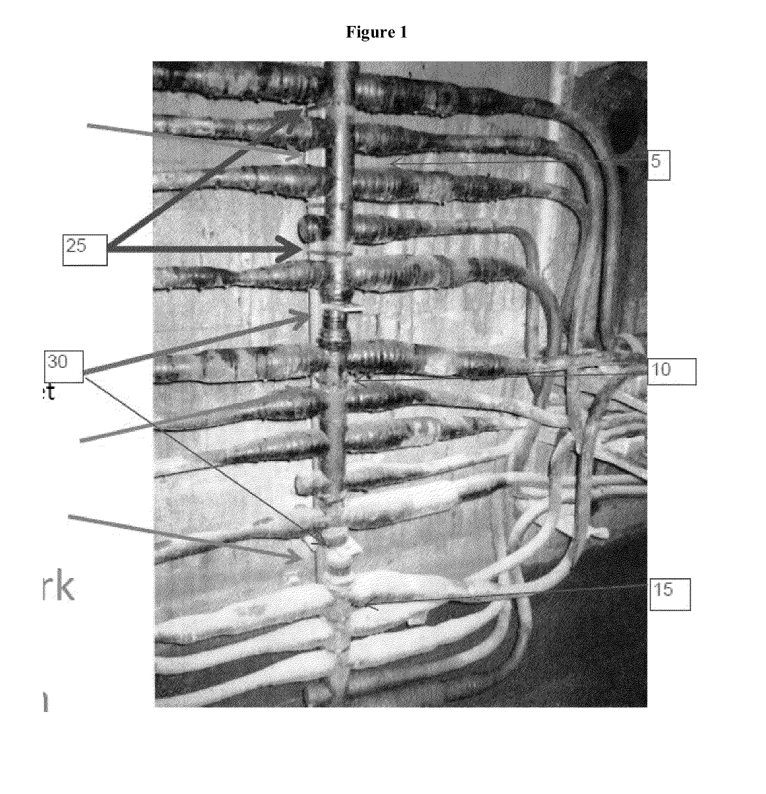

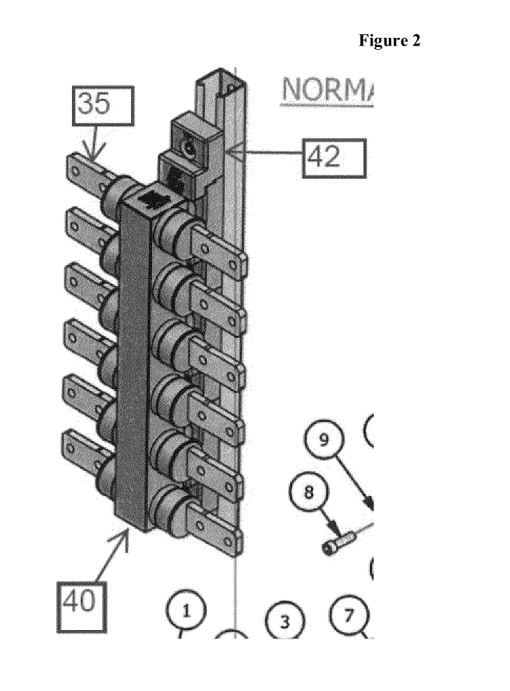

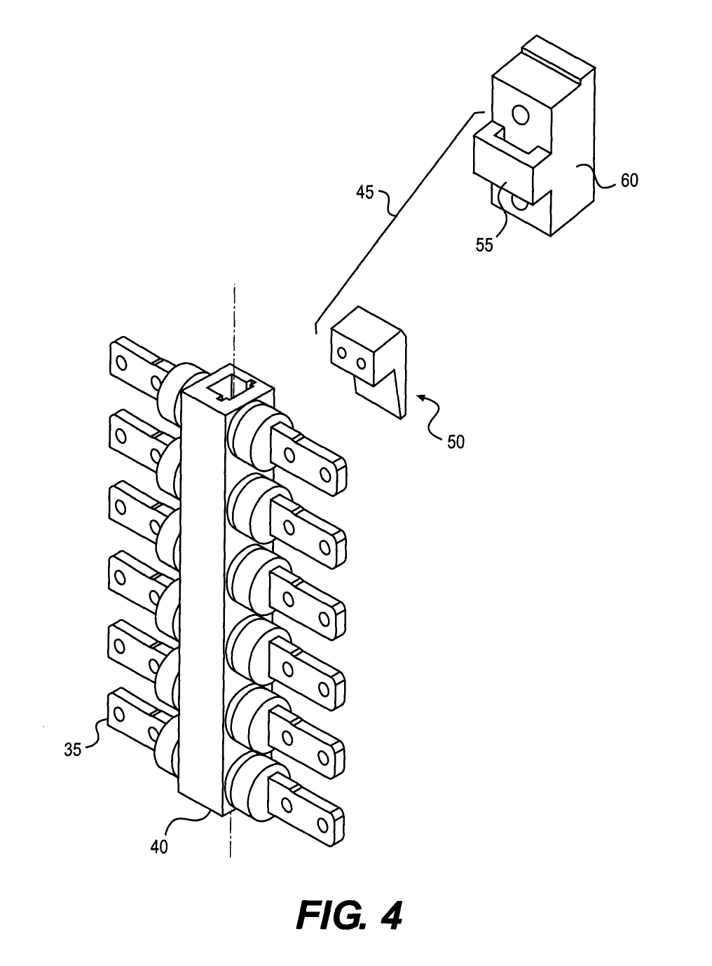

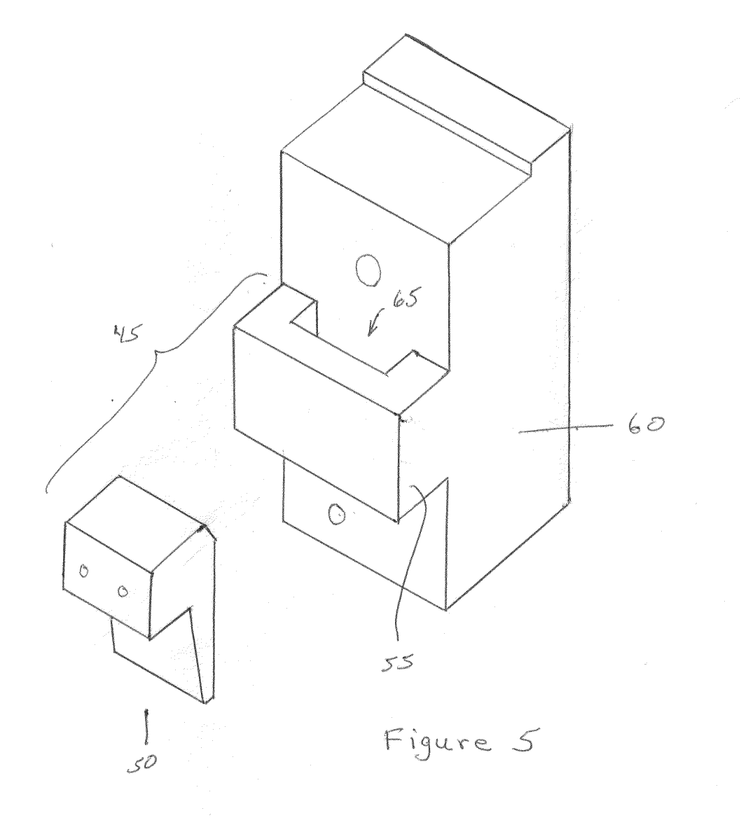

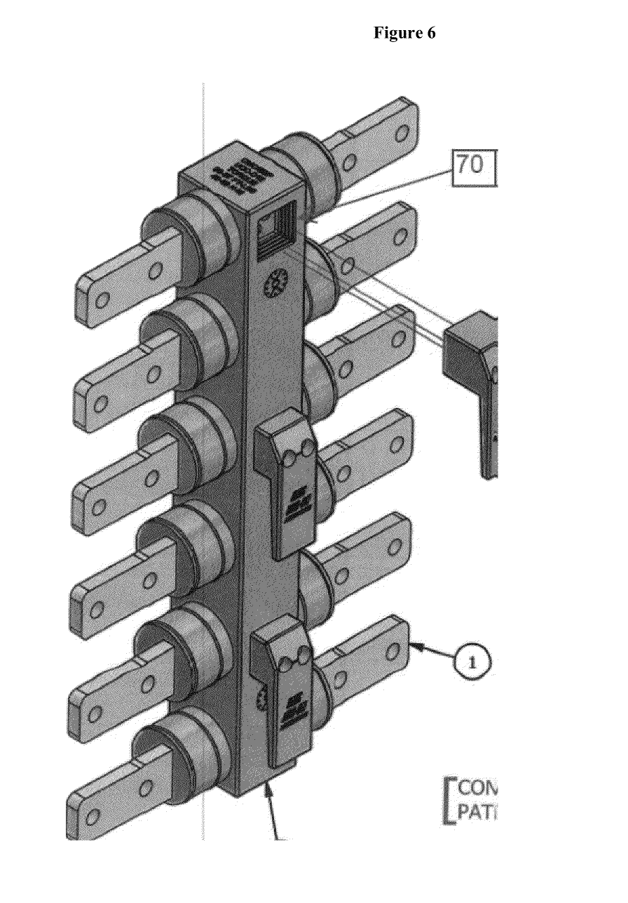

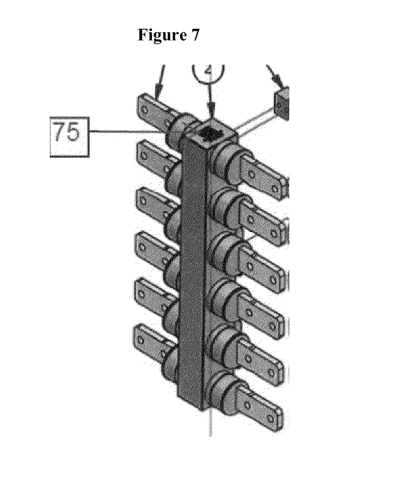

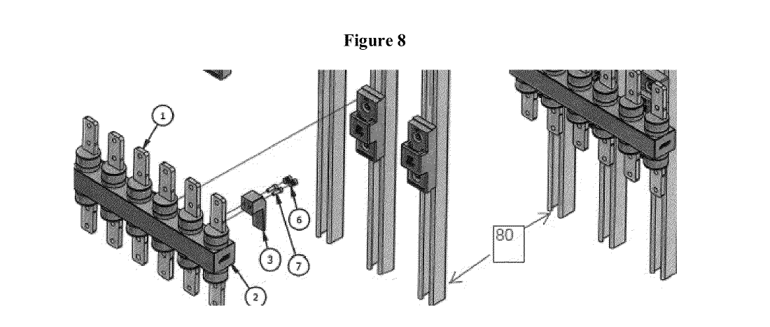

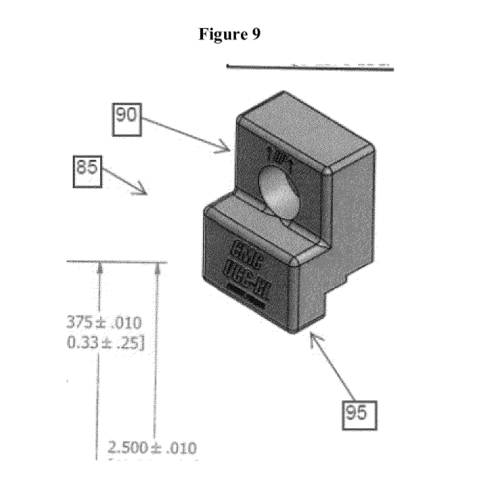

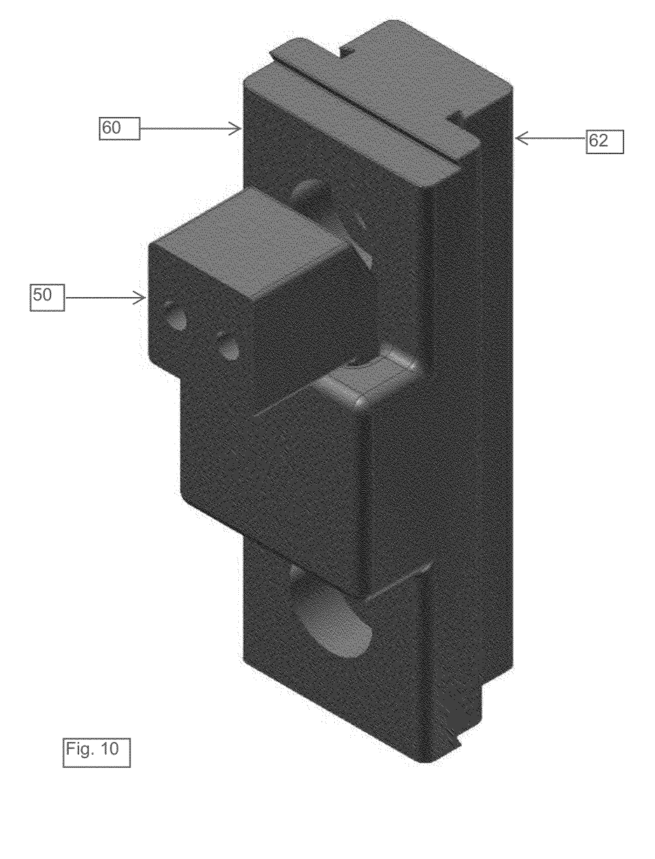

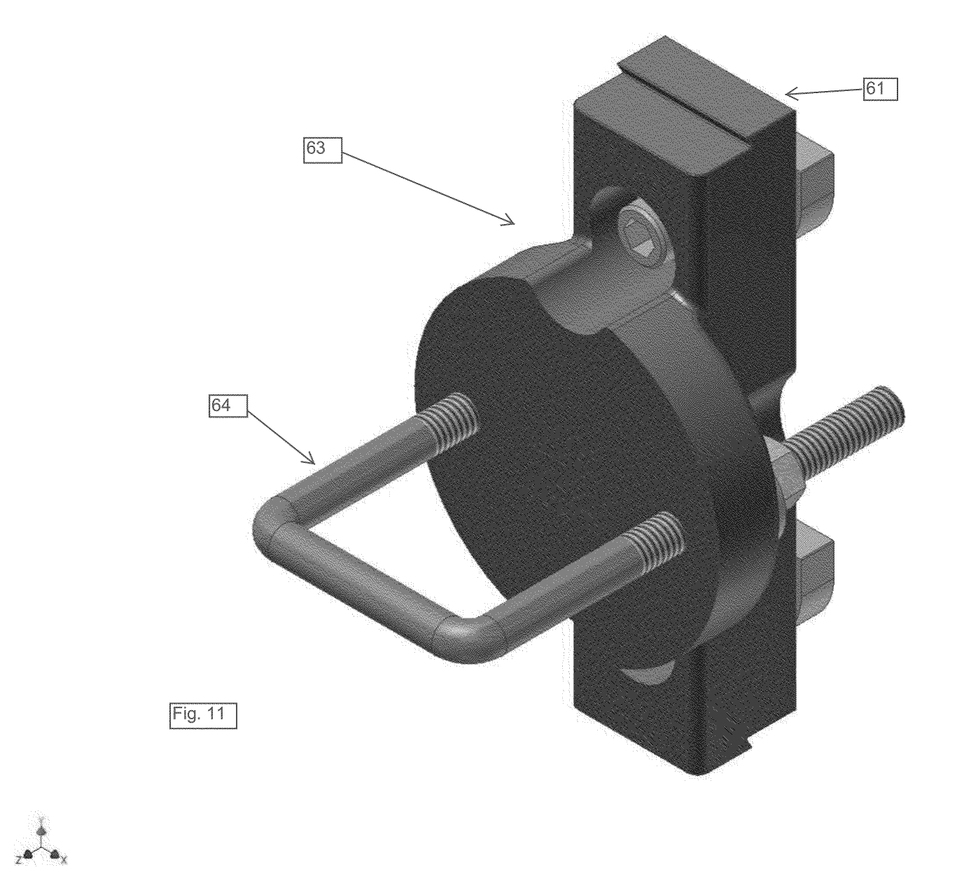

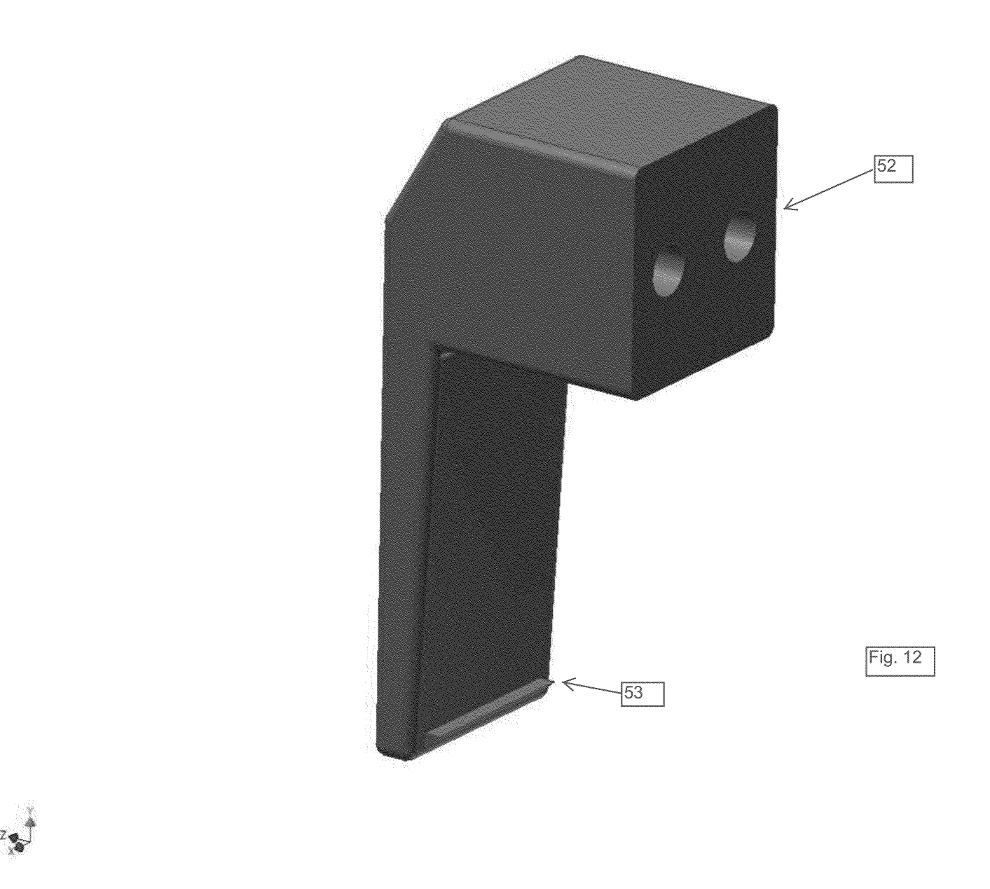

FIG. 4 is an alternate view of the FIG. 2 embodiment.

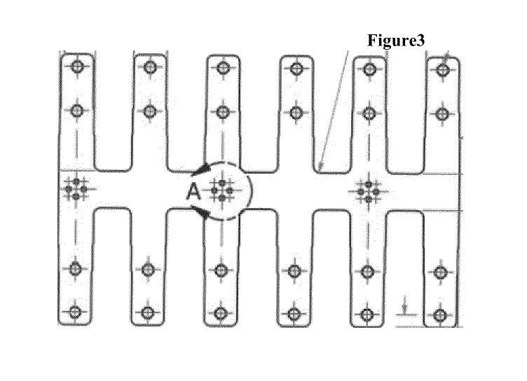

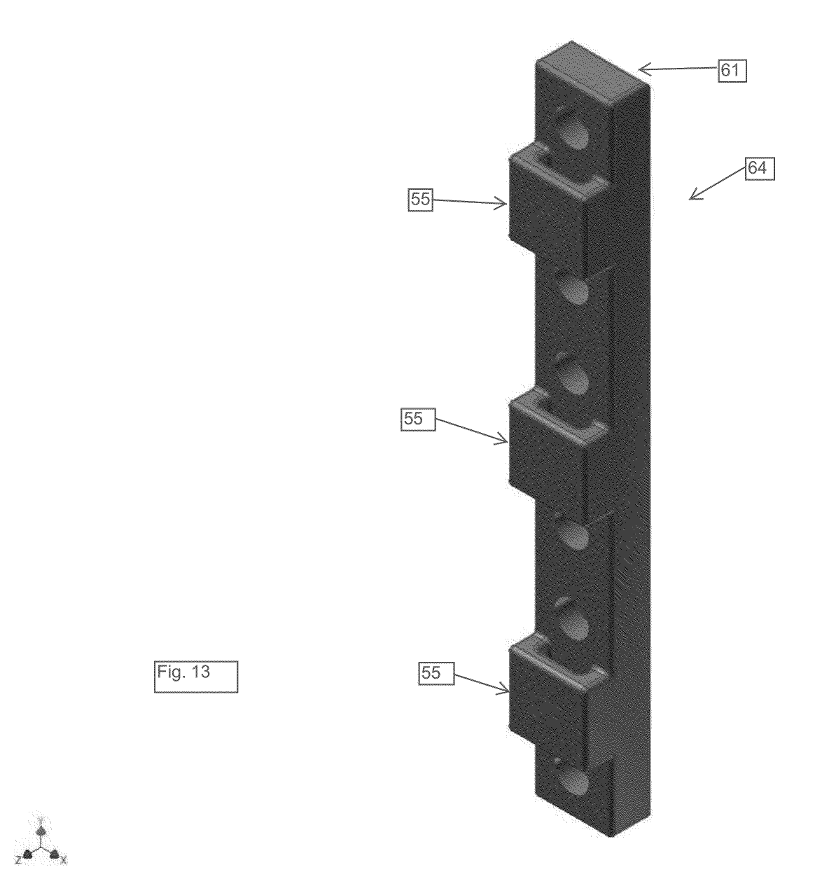

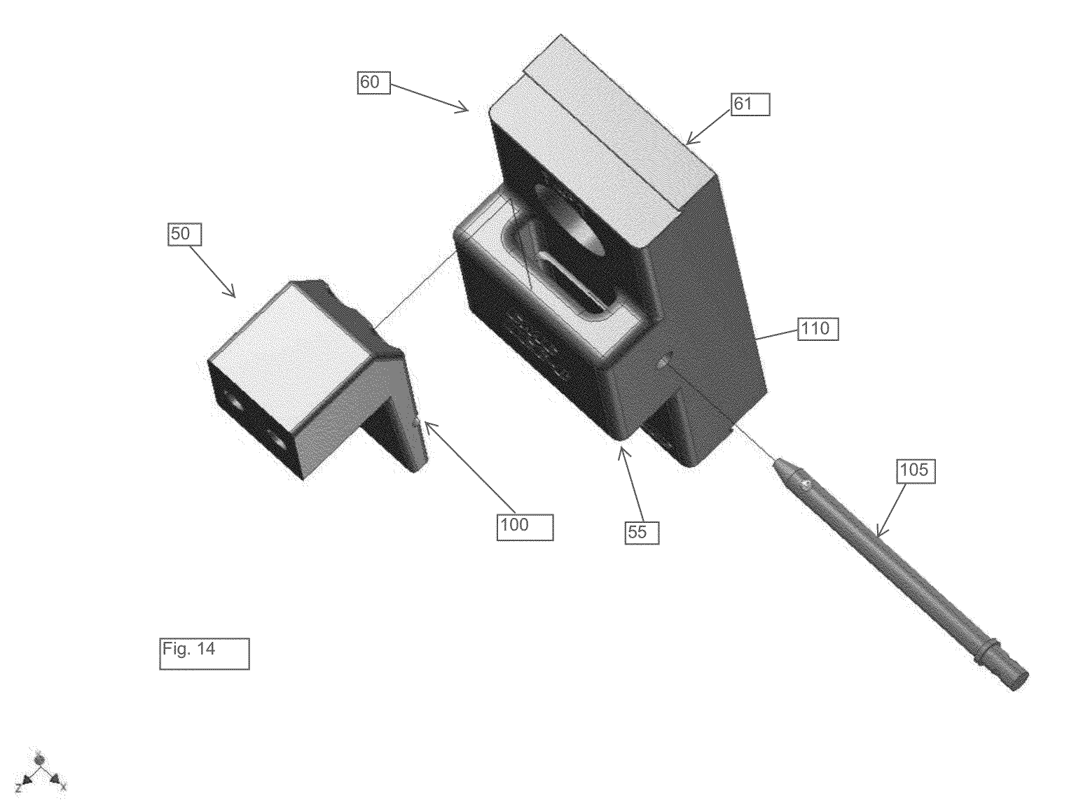

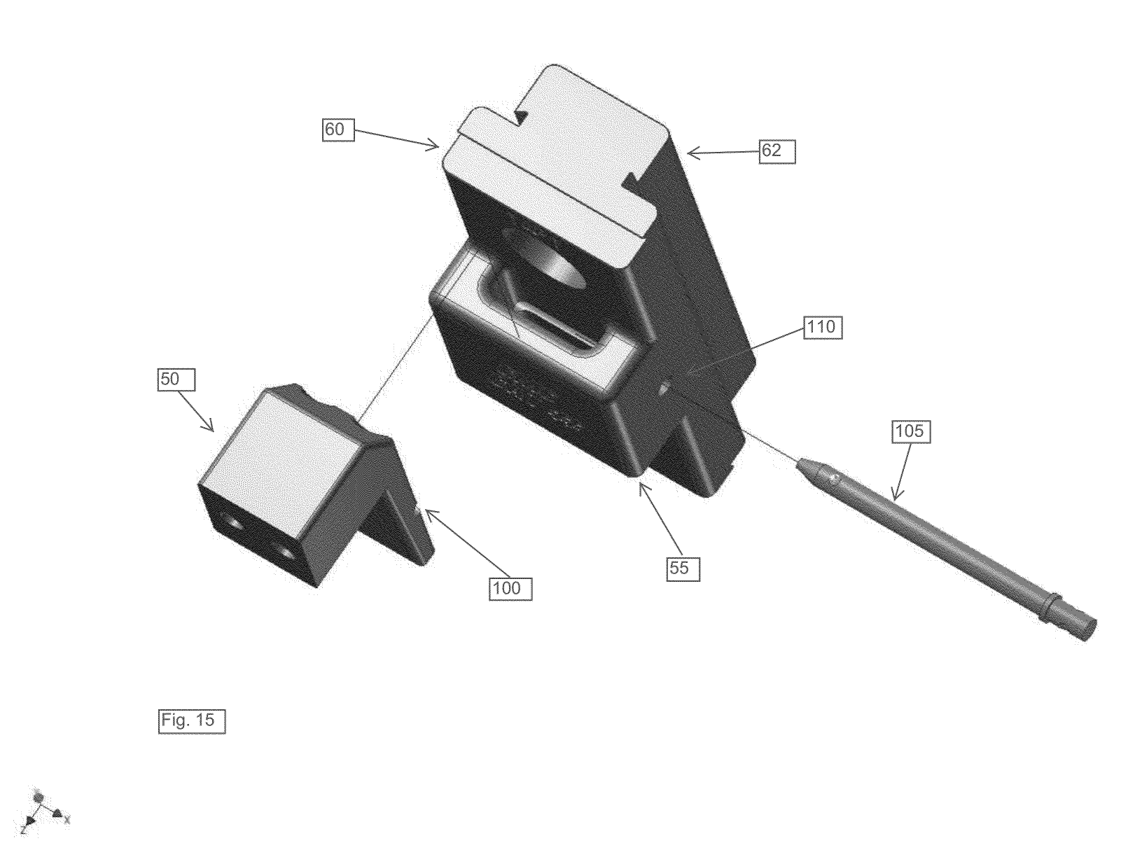

FIG. 5 is an alternate view of the FIG. 3 embodiment.

FIG. 6 is a perspective view of an alternate embodiment in accordance with embodiments of the present invention.

FIG. 7 is a perspective view of an alternate embodiment in accordance with embodiments of the present invention.

FIG. 8 is a perspective view of an alternative embodiment in accordance with the present invention with a horizontal arrangement of the housing and multi-terminal conductor.

FIG. 9 is a perspective view of further embodiment in accordance with embodiments of the present invention.

FIG. 10 is a perspective view of an alternate embodiment of a base member.

FIG. 11 is a perspective view of an alternative embodiment in accordance with the present invention.

FIG. 12 is a perspective view of an alternative embodiment of a connector element in accordance with the present invention.

FIG. 13 illustrates an alternative embodiment of a base member in accordance with the present invention.

FIG. 14 is a perspective view of an alternative embodiment in accordance with the present invention.

FIG. 15 is a perspective view of an alternative to the FIG. 14 embodiment.

### DETAILED DESCRIPTION OF PREFERRED EMBODIMENTS

FIG. 2 is a schematic, perspective view of an embodiment in accordance with the present invention. Referring to FIG. 2, a connector system in accordance with the present invention includes a multi-terminal conductor 35. FIG. 3 is a schematic illustration of an exemplary multi-terminal conductor in accordance with an embodiment of the present invention. The conductor can comprise any conductive or semi-conductive material. In one example embodiment, the conductor comprises a copper tin plated metal. The size and thickness of the conductor depends upon the given application. For illustrative purposes only, in a power connection, the conductor can have an example thickness in the range of about 0.25 inch to about 0.5 inch.

Referring to FIG. 2, the multi-terminal connector 35 is partially housed by a housing 40. The housing 40 preferably comprises an insulating material. For example, in one illustrative embodiment, the housing 40 comprises EPDM rubber or santoprene.

FIG. 4 is a perspective, schematic view an embodiment of a connector system in accordance with the present invention. In FIG. 4, reference numeral 45 identifies an example embodiment of complementary connection elements. This illustrative embodiment includes a male complementary connection element 50 and a female complementary connection element 55. The illustrative embodiment in FIG. 4 shows two connections: male complementary connection element 50 can be mechanically mounted to the housing 40; and female complementary connection element 55 is formed as part of a base member 60. Obviously, any other connections can be utilized, such as pressure fit, snap type fittings, compression connections and others suited to a particular design of an embodiment of the present invention. FIG. 12 is a perspective view of an alternative embodiment of a connector element 50 in accordance with the present invention. In FIG. 12, reference number 52 identifies an alternate embodiment of a male complementary member. The alternate embodiment includes a clip portion 53. The clip portion a bottom portion of female complementary connection element 55 shown in FIG. 5.

FIG. 5 is a schematic, perspective view of a portion of the FIG. 4 embodiment. In the illustrative embodiment shown in FIG. 5, the male complementary member 50 engages opening 65 of the female complementary connection element 55 that is connected with the based member 60. Other suitable arrangements are also possible such as having the male complementary member 50 connected to the base member 60 and the female complementary member 50 on the housing 40. The female complementary member 50 could be located at any suitable location on the housing 40, such as on the back of the housing 40 as illustrated in the example of FIG. 6 or on the top of the housing 40 as shown in the example of FIG. 7 at 75. As another example, the housing and base member could have suitable complementary connection elements such as a press fit arrangement or a snap fit type connector arrangement, as well as simply being bolted or molded together.

FIG. 10 is a perspective view of an alternate embodiment of a base member 60. Referring to FIG. 10, the base member 60 has another illustrative shape portion, 62. The shaped portion 62 can engage a rail member (not shown) with a complimentary shape for engaging and holding the base member shaped portion 62.

FIG. 13 illustrates an alternative embodiment of a base member in accordance with the present invention. Referring to FIG. 13, the alternative embodiment comprises a base member 64 that includes multiple female complementary connection elements 55. In the exemplary illustration of FIG. 13, three female complementary connection elements 55 are shown. Any number of female complementary connection elements 55 can be employed in a base member 64. In addition, as discussed with respect to FIG. 5, the female complementary connection elements 55 shown in FIG. 13 can be interchanged with male complementary connection element 50 and the female complementary connection elements located on housing 40.

FIG. 11 is a perspective view of an alternative embodiment in accordance with the present invention. In FIG. 11, an alternative embodiment of a base member 63. The back portion 61 of the base member 63 is illustrated as relatively flat. The back portion 61 can have any suitable shape, for example, the shaped portion 62 shown in FIG. 10. The base member 63 shown in FIG. 11 includes a “U” bolt member 64. The “U” bolt member 64 can engage a male complimentary member 50.

FIG. 8 is a perspective view of an alternative embodiment in accordance with the present invention with a horizontal arrangement of the housing and multi-terminal conductor. In FIG. 8, the housing 40 is horizontal. In this and other embodiments, the female complementary connection element can be on a side of the housing 40, e.g., on either side of the housing having the terminals thereon. The example embodiment shown in FIG. 8 illustrates the base member 60 connected to one or more mounting members 80. The same flexibility in the structure of the complementary connection elements discussed above applies to an embodiment such as shown in FIG. 8. Moreover, the above embodiments can also have a base member 60 connected to a mounting member or members 80. The mounting member 80 is not needed to practice embodiments of the invention; and the base member 60 can be mounted directly to a surface without the use of a mounting member 80.

FIG. 9 is a perspective view of further embodiment in accordance with embodiments of the present invention. FIG. 9 illustrates another example embodiment of a base member 85. In the example of FIG. 9, the base member 85 has an upper portion 90 and a lower portion 95. The lower portion 95 corresponds to the mil complementary connection element 50 discussed above with respect to the other embodiments. It can engage any of the locations of the female complementary connection element discussed above.

FIG. 14 is a perspective view of an alternative embodiment in accordance with the present invention. The FIG. 14 embodiment secures the male complementary connection element 50 within the female complementary connection element 55 via a pin 105 inserted through an opening 110. In the illustrated embodiment, the pin 105 engages a detent 110. Alternatively, the pin could pass through the male complementary connection element 50. In a variation, the opening 110 could be on another portion of the female complementary connection member 55, such as on a front portion. In the FIG. 14 embodiment the back portion 61 of the base member 60 is illustrated as flat. FIG. 15 is a perspective view of an alternative to the FIG. 14 embodiment. In the FIG. 15 embodiment, the back portion 61 is an engagement shape such as discussed with respect to FIG. 10.

Having thus described the invention of the present application in detail and by reference to embodiments thereof, it will be apparent that modifications and variations are possible without departing from the scope of the invention defined in the appended claims.

What is claimed is:

1. A connector system comprising:
a multi-terminal conductor;
a housing arranged to at least partially house the multi-terminal conductor;
a base member; and
complementary connection elements configured to provide connection of the housing and the base member.

2. A connector system according to claim 1, wherein the complementary connection elements are configured to provide removable connection of the housing and the base member.

3. A connector system according to claim 1, wherein the housing includes a male complementary connection element, and the base member includes a female complementary connection element.

4. A connector system according to claim 1, wherein the housing includes a female complementary connection element, and the base member includes a male complementary connection element.
